(19) United States
(12) Patent Application Publication
(10) Pub. No.: US 2025/0212276 A1
(43) Pub. Date: Jun. 26, 2025

(54) SWITCH LINK OPERATION WITHIN AND ACROSS MULTI-LINK DEVICES IN A WI-FI NETWORK

(71) Applicant: Cisco Technology, Inc., San Jose, CA (US)

(72) Inventors: Binita Gupta, San Diego, CA (US); Brian Donald Hart, Sunnyvale, CA (US); Malcolm Muir Smith, Richardson, TX (US); Indermeet Singh Gandhi, San Jose, CA (US)

(21) Appl. No.: 18/989,592

(22) Filed: Dec. 20, 2024

Related U.S. Application Data
(60) Provisional application No. 63/612,513, filed on Dec. 20, 2023.

(51) Int. Cl. H04W 76/15; H04W 88/10

(52) U.S. Cl. CPC H04W 76/15; H04W 88/10

(57) ABSTRACT

In one aspect, a method includes generating, by a Non-Access Point Multi-link Device (Non-AP MLD), a switch link signaling to indicate a switch link operation to trigger a deletion of a first communication link between the Non-AP MLD and a current AP MLD and addition of a second communication link; specifying, by the Non-AP MLD, a respective link identifier of the first communication link and a respective link identifier of the second communication link in the switch link signaling; sending, by the Non-AP MLD, the switch link signaling to the current AP MLD that includes the switch link operation, the respective link identifier of the first communication link, and the respective link identifier of the second communication link; and receiving, at the Non-AP MLD, a response frame indicating one of an acceptance or rejection of the deletion of the first communication link and the addition of the second communication link.

### CROSS-REFERENCE TO RELATED APPLICATIONS

This application claims priority to and the benefit of U.S. Prov. App. No. 63/612,513, filed on Dec. 20, 2023, which is expressly incorporated herein by reference in the entirety.

### TECHNICAL FIELD

The present technology pertains to wireless communication network, and more specifically, to signaling procedures for enabling a switch link operation for a device to switch wireless communication links in a Multi-Link Operation Wireless network.

### BACKGROUND

Wi-Fi technology has undergone continuous evolution and innovation since its inception, resulting in significant advancements with each new generation. Following Wi-Fi 5 (802.11ac) there has been Wi-Fi 6 (802.11ax), Wi-Fi 7 (802.11bc), and soon there will be Wi-Fi 8 (802.11bn) and Wi-Fi 9, each new Wi-Fi generation brings notable improvements in speed, capacity, efficiency, and overall performance.

Wi-Fi 5 introduced substantial upgrades over its predecessor, Wi-Fi 4 (802.11n). It introduced the use of wider channel bandwidths, multi-user Multiple-Input Multiple-Output (MIMO), and beamforming technologies. These advancements significantly increased data transfer rates and improved network capacity, allowing multiple devices to simultaneously connect and communicate more efficiently. Wi-Fi 6/6E included enhanced orthogonal frequency-division multiple access (OFDMA) and target wake time (TWT) mechanisms and included greater frequency and improved overall spectral efficiency and power management and better performance in crowded areas. Wi-Fi 7 (802.11be) delivers speeds of up to 30 Gbps, utilizing multi-band operation, wider bandwidth, advanced MIMO techniques, and improved modulation schemes. Wi-Fi 7 also focuses on reducing latency and enhancing security features.

Wi-Fi 8 (802.11bn) aims to revolutionize wireless connectivity by providing ultra-high reliability enabling rich experiences for QoS demanding applications such as cloud gaming, AR/VR, industrial IoT, wireless TSN etc., Wi-Fi 8 is expected to introduce advancements like seamless roaming, multi-AP coordination for predictable QoS, enhanced power saving and advanced beamforming techniques paving the way for futuristic applications and seamless connectivity experiences.

As Wi-Fi technology continues to evolve, each new Wi-Fi generation brings improvements that address the growing demands of modern networks, including increased device density, higher data rates, lower latency, improved reliability and better overall network performance. These advancements play a crucial role in enabling emerging technologies, supporting the proliferation of smart devices, and transforming the way we connect and communicate in an increasingly interconnected world.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a block diagram of an example wireless communication network according to some aspects of the present disclosure.

FIG. 2A illustrates an example of a single floor of building equipped with wireless communication according to some aspects of the present disclosure.

FIG. 2B depicts an illustrative schematic diagram for MLO between an AP MLD with affiliated logical entities and a Non-AP MLD with affiliated logical entities according to some aspects of the present disclosure.

FIG. 3 illustrates an example of a seamless mobility domain according to some aspect of the present disclosure.

FIG. 4 illustrates an example encoding of a link reconfiguration element of a management frame to trigger a switch link operation according to some aspects of the present disclosure.

FIG. 5 illustrates an example of a Reconfiguration ML element modified to include switch link operation information according to some aspects of the present disclosure.

FIG. 6A illustrates an example of a signaling exchange between a Non-AP MLD and a current AP MLD for performing switch link operation according to some aspects of the present disclosure.

FIG. 6B illustrates an example of a signaling exchange between a Non-AP MLD and a Current AP MLD for performing switch link operation across multiple AP MLDs according to some aspects of the present disclosure.

FIG. 7 illustrates an example of a switch link operation process according to some aspects of the present disclosure.

FIG. 8 shows an example of computing system according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

### Abbreviations—

Access Point (AP)
Advanced Encryption Standard (AES)
Association and key management (AKM)
Basic service set (BSS)
Extended Service Set (ESS)
Extremely high throughput (EHT)
Fast Transition (FT)
Mobile Device Management (MDM)
Multi-Link Device (MLD)
Multi-link Operation (MLO)
Network Interface Device (NID)
Pairwise Master Key (PMK)
Pairwise Transient Key (PTK)
Robust Security Network Element (RSNE)
Seamless Mobility Domain (SMD)
Service Set Identifier (SSID)
Station (STA)
Wi-Fi Protected Access (WPA)
Wireless Local Area Network (WLAN)
Wireless LAN Controller (WLC)

Mobility Domain MLD (MDM), also Seamless Mobility Domain (SMD) refer to a logical entity including multiple AP MLDs to which a STA (a Wi-Fi client device or Non-AP MLD) associates.

As used herein, the term “configured” shall be considered to be used interchangeably with configured and configurable, unless the term “configurable” is explicitly used to distinguish from “configured.” The proper understanding of the term will be apparent to persons of ordinary skill in the art in the context in which the term is used.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

IEEE 802.11, commonly referred to as Wi-Fi, has been around for three decades and has become arguably one of the most popular wireless communication standards, with billions of devices supporting more than half of the worldwide wireless traffic. The increasing user demands in terms of throughput, capacity, latency, spectrum, and power efficiency calls for updates or amendments to the standard to keep up with them. As such, Wi-Fi generally has a new amendment after every few years with its own characteristic features. In the earlier generations, the focus was primarily higher data rates, but with ever increasing density of devices, area efficiency has become a major concern for Wi-Fi networks. Due to this issue, the last (802.11 be (Wi-Fi 7)) amendments focused more on efficiency though higher data rates were also included. The next expected update to IEEE 802.11 is coined as Wi-Fi 8. Wi-Fi 8 will attempt to further enhance throughput and minimize latency to meet the ever-growing demand for the Internet of Things (IOT), high resolution video streaming, low-latency wireless services, etc.

Multiple Access Point (AP) coordination and transmission in Wi-Fi refers to the management of multiple access points in a wireless network to avoid interference and ensure efficient communication between the STA devices and the network. When multiple access points are deployed in a network-for instance in buildings and office complexes-they operate on the same radio frequency, which can cause interference and degrade the network performance. To mitigate this issue, access points can be configured to coordinate their transmissions and avoid overlapping channels.

Wi-Fi 7 introduced the concept of multi-link operation (MLO), which gives the devices (Access Points (APs) and Stations (STAs)) the capability to operate on multiple links (or even bands) at the same time. MLO introduces a new paradigm to multi-AP coordination which was not part of the earlier coordination approaches. MLO is considered in Wi-Fi-7 to improve the throughput of the network and address the latency issues by allowing devices to use multiple links.

A multi-link device (MLD) may have several “affiliated” devices, each affiliated device having a separate PHY interface, and the MLD having a single link to the Logical Link Control (LLC) layer. In IEEE 802.11be, a multi-link device (MLD) is defined as: “A device that is a logical entity and has more than one affiliated station (STA) and has a single medium access control (MAC) service access point (SAP) to logical link control (LLC), which includes one MAC data service” (see: LAN/MAN Standards Committee of the IEEE Computer Society, Amendment 8: Enhancements for extremely high throughput (EHT), IEEE P802.11 be™/DO.1, September 2020, section 3.2). Connection(s) with an MLD on the affiliated devices may occur independently or jointly. A preliminary definition and scope of a multi-link element is described in section 9.4.2.247b of aforementioned IEEE 802.11 be draft. An idea behind this information clement/container is to provide a way for multi-link devices (MLDs) to share the capabilities of different links with each other and facilitate the discovery and association processes. However, this information element may still be changed, or new mechanisms may be introduced to share the MLO information (e.g., related to backhaul usage).

In multi-link operation (MLO) both STA and APs can possess multiple links that can be simultaneously active. These links may or may not use the same bands/channels.

MLO allows sending PHY protocol data units (PPDUs) on more than one link between a STA and an AP. The links may be carried on different channels, which may be in different frequency bands. Based on the frequency band and/or channel separation and filter performance, there may be restrictions on the way the PPDUs are sent on each of the links.

MLO may include a basic transmission mode, an asynchronous transmission mode, and a synchronous transmission mode.

In a basic transmission mode, there may be multiple primary links, but a device may transmit PPDU on one link at a time. The link for transmission may be selected as follows. The device (such as an AP or a STA) may count down a random back off (RBO) on both links and select a link that wins the medium for transmission. The other link may be blocked by in-device interference. In basic transmission mode, aggregation gains may not be achieved.

In an asynchronous transmission mode, a device may count down the RBO on both links and perform PPDU transmission independently on each link. The asynchronous transmission mode may be used when the device can support simultaneous transmission and reception with bands that have sufficient frequency separation such as separation between the 2.4 GHz band and the 5 GHz band. The asynchronous transmission mode may provide both latency and aggregation gains.

In a synchronous PPDU transmission mode, the device may count down the RBO on both links. If a first link wins the medium, both links may transmit PPDUs at the same time. The transmission at the same time may minimize in-device interference and may provide both latency and aggregation gains.

Multi-AP coordination and MLO are two features directed to improve the performance of Wi-Fi networks as the Multi-AP coordination is directed toward utilizing (distributed) coordination between different APs to reduce inter-Basic Service Set (BSS) interference for improved spectrum utilization in dense deployments, and the MLO supports high data rates and low latency by leveraging flexible resource utilization offered by the use of multiple links for the same device.

### Overview

The present disclosure is directed to providing signaling procedure for triggering a switch link operation in a Multi-Link Operation (MLO) network in which one or more Non-AP MLD devices are connected to a wireless network provided using one or more AP MLDs.

In one aspect, a method includes generating, by a Non-Access Point Multi-link Device (Non-AP MLD), a switch link signaling to indicate a switch link operation to trigger a deletion of a first communication link between the Non-AP MLD and a current AP MLD and addition of a second communication link; specifying, by the Non-AP MLD, a respective link identifier of the first communication link and a respective link identifier of the second communication link in the switch link signaling; sending, by the Non-AP MLD, the switch link signaling to the current AP MLD that includes the switch link operation, the respective link identifier of the first communication link, and the respective link identifier of the second communication link; and receiving, at the Non-AP MLD, a response frame indicating one of an acceptance or rejection of the deletion of the first communication link and the addition of the second communication link.

In another aspect, the switch link signaling includes a reconfiguration multi-link clement, and generating the switch link signaling includes adding the switch link operation in a reconfiguration operation type subfield of the reconfiguration multi-link element.

In another aspect, sending the switch link signaling includes sending a link reconfiguration request frame that includes the reconfiguration multi-link element.

In another aspect, the method further includes receiving a link reconfiguration notification frame from the current AP MLD, the link reconfiguration notification frame including the switch link operation, wherein the switch link signaling is generated based on the switch link operation received as part of the link reconfiguration notification frame.

In another aspect, the first communication link and second communication link are associated with the current AP MLD.

In another aspect, the second communication link is associated with a target AP MLD, and the current AP MLD and the target AP MLD are not physically co-located.

In another aspect, the current AP MLD and the target AP MLD are part of a seamless mobility domain, and wherein a seamless mobility domain identifier is included in the switch link signaling that identifies the seamless mobility domain to which the current AP MLD and target AP MLD belong.

In another aspect, the respective link identifier of the second communication link includes a respective MAC address of the target AP MLD.

In another aspect, upon receiving the switch link signaling, as part of a reconfiguration request frame, from the Non-AP MLD, the current AP MLD performs an AP-to-AP exchange with the target AP MLD to add the second communication link with the target AP MLD and delete the first communication link with the current AP MLD.

In another aspect, the switch link signaling comprises a first reconfiguration multi-link clement indicating delete link operation for the first communication link and a second reconfiguration multi-link element indicating add link operation for the second communication link, and another indication to trigger the switch link operation, and sending the switch link signaling includes sending a link reconfiguration request frame that includes the first reconfiguration multi-link element and the second reconfiguration multi-link element.

In one aspect, a Non-Access Point Multi-Link Device (Non-AP MLD) includes one or more memories having computer-readable instructions stored therein and one or more processors. The one or more processors are configured to execute the computer-readable instructions to generate a switch link signaling to indicate a switch link operation to trigger a deletion of a first communication link between the Non-AP MLD and a current AP MLD and addition of a second communication link; specify a respective link identifier of the first communication link and a respective link identifier of the second communication link in the switch link signaling; send the switch link signaling to the current AP MLD that includes the switch link operation, the respective link identifier of the first communication link, and the respective link identifier of the second communication link; and receive a response frame indicating one of an acceptance or rejection of the deletion of the first communication link and the addition of the second communication link.

In one aspect, one or more non-transitory computer-readable media comprising computer-readable instructions, which when executed by one or more processors of a Non-Access Point Multi-Link Device (Non-AP MLD), cause the Non-AP MLD to generate a switch link signaling to indicate a switch link operation to trigger a deletion of a first communication link between the Non-AP MLD and a current AP MLD and addition of a second communication link; specify a respective link identifier of the first communication link and a respective link identifier of the second communication link in the switch link signaling; send the switch link signaling to the current AP MLD that includes the switch link operation, the respective link identifier of the first communication link, and the respective link identifier of the second communication link; and receive a response frame indicating one of an acceptance or rejection of the deletion of the first communication link and the addition of the second communication link.

### EXAMPLE EMBODIMENTS

In Wi-Fi 8, support for seamless or smooth roaming capability is a strong consideration to improve Wi-Fi roaming quality. In particular, to support smooth roaming or mobility in a campus wide Wi-Fi network, Wi-Fi client devices can create an association with the campus-network (also referenced herein as an ESS, an NID, and/or an MDM) instead of creating an association with an individual AP MLD. The ESS might be represented by a mobility domain or a global network (e.g., NID). Further, within a single mobility domain, there can be multiple “sub-mobility domains,” where each of the multiple “sub-mobility domains” may map to a single campus.

Currently, the Wi-Fi client device creates its association with the ESS network represented by a (sub) Mobility Domain Multi-Link Device (MLD), instead of associating with a single AP MLD within the ESS. Such an architecture can enable the Wi-Fi client device to roam seamlessly between AP MLDs without requiring reassociation and reestablishment of contexts with each new AP MLD. Further, because the Wi-Fi client device associates with the Mobility Domain MLD covering all the AP MLDs of the ESS, such an architecture also reduces roaming time to realize seamless roaming.

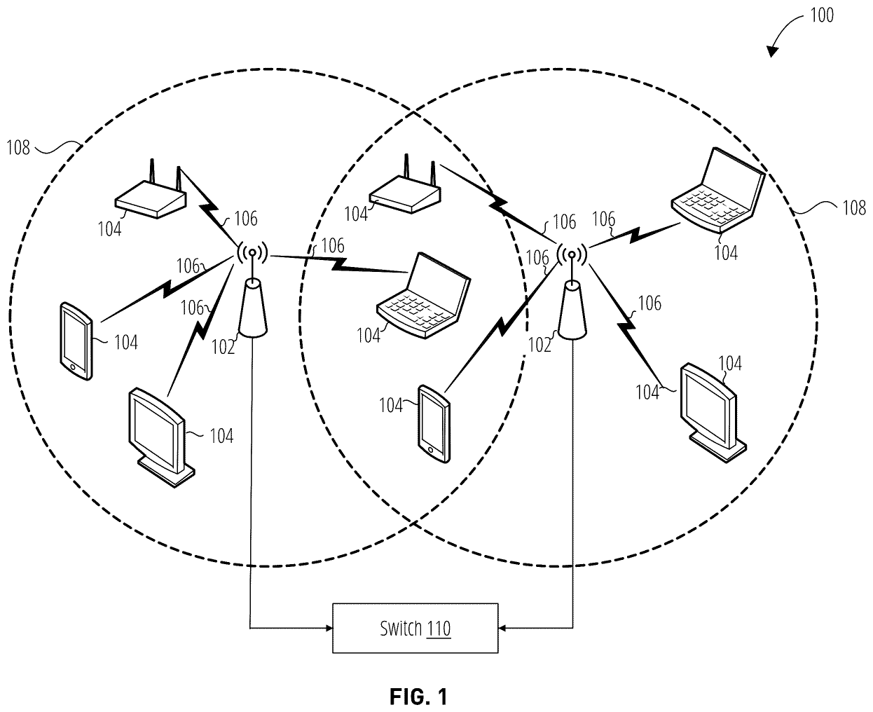

FIG. 1 illustrates a block diagram of an example wireless communication network according to some aspects of the present disclosure. According to some aspects, wireless communication network 100 may be an example of a wireless local area network (WLAN) such as a Wi-Fi network. For example, wireless communication network 100 may be a network implementing at least one of the IEEE 802.11 family of wireless communication protocol standards and amendments thereof (such as that defined by the IEEE 802.11-2016 specification or amendments thereof including, but not limited to, 802.11ay, 802.11ax, 802.11az, 802.11ba and 802.11bc). Additionally, wireless communication network 100 may implement future versions and amendments of wireless communication protocol standards and amendments thereof such as 802.11bn and be modified according to the present disclosure to include the features contained herein. The wireless communication network 100 may include numerous wireless communication devices such as an AP actor, which can be one or more of a non-MLD AP, an AP affiliated with an AP MLD, and/or an AP MLD. In the examples presented herein, the AP actor can exclude an upper UMAC. Therefore, the AP actor can include the lower UMAC, LMAC, and/or PHY. Additionally, the WLAN can include one or more of STA actors 104, which can be one or more of a non-MLD STA, a STA affiliated with a Non-AP MLD, and/or a Non-AP MLD. As illustrated, wireless communication network 100 also may include multiple AP actors such as AP actors 102 (may also be referred to as simply AP). AP actors 102 can be coupled to one another through a switch 110. While AP actors 102 are shown as being coupled to one another through a switch 110, the network can provide another device that allows the coupling of the multiple AP actors.

Each of STA actors 104 also may be referred to as a mobile station (MS), a mobile device, a mobile handset, a wireless handset, an access terminal (AT), a user equipment (UE), a subscriber station (SS), client, or a subscriber unit, among other examples. STA actors 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples. In other examples, the STA actors 104 can be referred to as clients and/or client devices.

Any one of the AP actors 102 and an associated set of STA actors (e.g., STA actors 104) may be referred to as a basic service set (BSS), which is managed by a respective AP actor of AP actors 102. FIG. 1 additionally shows an example coverage area 108 of the each of AP actors 102, which may represent a basic service area (BSA) of wireless communication network 100. As illustrated, three of STA actors 104 are within the BSA of each of AP actors 102. The BSS may be identified to users by a service set identifier (SSID), where the BSS might be one of many in the SSID. The BSS may be identified to other devices by a unique (or substantially unique) basic service set identifier (BSSID). One or more of AP actors 102 periodically broadcasts beacon frames (“beacons”) including the BSSID to enable STA actors 104 within wireless range of AP actors 102 to “associate” or re-associate with AP actors 102 to establish a respective communication link of communication links 106 (hereinafter also referred to as a “Wi-Fi link”), or to maintain the communication links 106, with the AP actors 102. For example, the beacons may include an identification of a primary channel used by the respective AP actor of AP actors 102 as well as a timing synchronization function for establishing or maintaining timing synchronization with AP actors 102. AP actors 102 may provide communication links 106 to STA actors 104 and therefore access to external networks. While the example has been described in regard to AP actors 102 and STA actors 104, the present disclosure extends such that an AP actor may provide access to external networks to various STA actors in a WLAN via the communication links 106.

To establish the communication links 106 with any one of AP actors 102, each of STA actors 104 is configured to perform passive or active scanning operations (“scans”) on frequency channels in one or more frequency bands (for example, the 2.4 GHZ, 5 GHZ, 6 GHZ or 60 GHZ bands). To perform passive scanning, STA actors 104 listen for beacons, which are transmitted by a respective AP actor of AP actors 102 at or near a periodic time referred to as the target beacon transmission time (TBTT) (measured in time units (TUs) where one TU may be equal to 1024 microseconds (μs)). To perform active scanning, STA actors 104 generate and sequentially transmits probe requests on each channel to be scanned and listens for probe responses from AP actors 102. STA actors 104 may be configured to identify or select an AP and thence a selected AP actor of AP actors 102 with which to associate based on the scanning information obtained through the passive or active scans, and to perform authentication and association operations to establish communication links 106 with the selected AP actor of AP actors 102. The selected AP actor of AP actors 102 assigns an association identifier (AID) to STA actors 104 at the culmination of the association operations, which selected AP actor of AP actors 102 uses to improve the efficiency of certain signaling to the STA actors 104.

The present disclosure modified the WLAN radio and baseband protocols for the PHY and medium access controller (MAC) layers. AP actors 102 and STA actors 104 transmit and receive wireless communications (hereinafter also referred to as “Wi-Fi communications”) to and from one another in the form of PHY protocol data units (PPDUs). AP actors 102 and STA actors 104 also may be configured to communicate over other frequency bands such as shared licensed frequency bands, where multiple operators may have a license to operate in the same or overlapping frequency band or bands.

Each PPDU is a composite structure that includes a PHY preamble and a payload in the form of one or more PHY service data unit (PSDU). The information provided in the preamble may be used by a receiving device to decode the subsequent data in an intended PSDU. In instances in which PPDUs are transmitted over a bonded channel, selected preamble fields may be duplicated and transmitted in each of the multiple component channels.

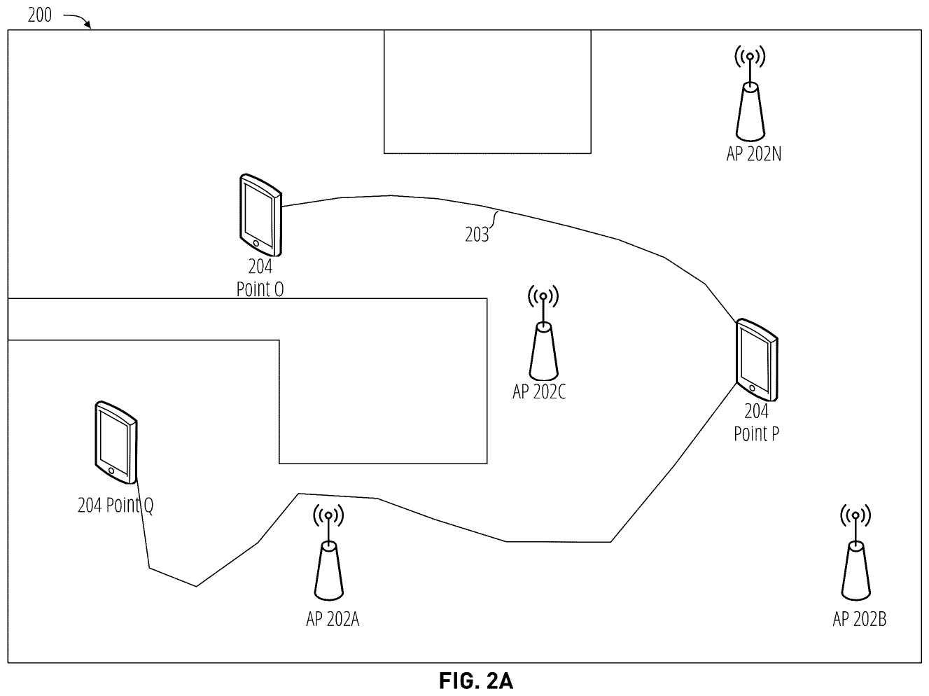

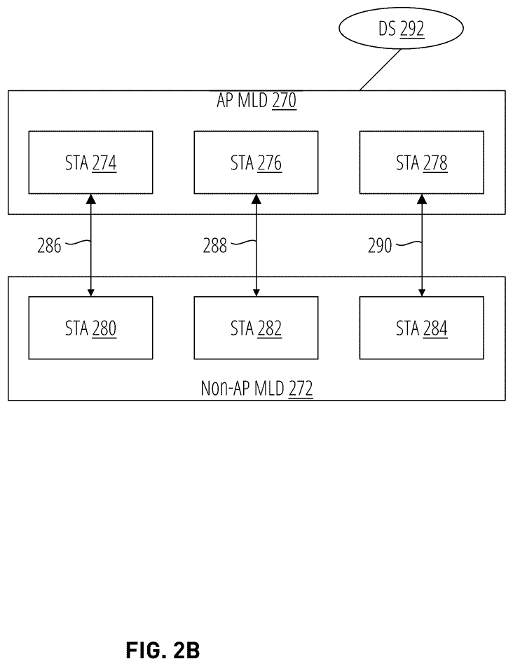

FIG. 2A illustrates an example of a single floor of building equipped with wireless communication according to some aspects of the present disclosure. While only a single floor 200 is illustrated a description equally applies to multiple floors in a building. Additionally, some of the floors in a building may not be contiguous, such that floors 1, 3, 4, and 8 span a network for a building that has floors 1-10. Thus, in at least one implementation the building can include one or more floors that do not have a network including one or more AP actors. As illustrated, single floor 200 includes AP actor 202A, AP actor 202B, AP actor 202C, and AP actor 202N. Each of the AP actor 202A, AP actor 202B, AP actor 202C, and AP actor 202N can have a respective coverage area such that an overall coverage area can span substantially the entire floor. In other examples, the overall coverage area can extend beyond the entire floor. In other examples, the overall coverage area can extend beyond the entire floor. Additionally, the coverage of an AP actor of AP actor 202A, AP actor 202B, AP actor 202C, and AP actor 202N may substantially overlap with the coverage of another AP actor of AP actor 202A, AP actor 202B, AP actor 202C, and AP actor 202N.

As illustrated by the line 203, STA actor 204 can move from point O to point P to point Q. When a STA actor 204 is moving around on a given floor, one or more of the AP actor 202A, AP actor 202B, AP actor 202C, and AP actor 202N can be considered to be nearest to the STA actor 204. Nearest as used in relation to the AP actor 202A, AP actor 202B, AP actor 202C, and AP actor 202N and STA actor 204 can include being physically nearest (for example, a Euclidean distance on the floor) and/or pathloss-nearest (for example, having the lowest wireless attenuation (pathloss) between AP actor, among all the AP actors, and STA actor). Additionally, the pathloss-nearest approach can be used to reduce the likelihood of connection between an AP actor on a floor above or below the STA actor 204. The location of the AP actor on the floor above or below might be closer in a Euclidean sense, but also not be a desirable AP for the connection of the device or station due to the floor location and/or possible signal interruption. The location of the AP actor on the floor above or below might be closer in a straight line and/or Euclidean sense, but also not be a desirable AP for the connection of the device or station due to the floor location and/or possible signal interruption. Additionally, the coverage of one or more AP actors can at least partially overlap with the coverage of one or more other AP actors. The present disclosure provides for selecting the AP actor and/or providing a communication pathway from one or more STA actors through one or more AP actors.

FIG. 2B depicts an illustrative schematic diagram for MLO between an AP MLD with affiliated logical entities and a Non-AP MLD with affiliated logical entities according to some aspects of the present disclosure.

Referring to FIG. 2B, two multi-link logical entities AP MLD 270 and Non-AP MLD 272 are shown. AP MLD 270 may include physical and/or logical affiliated AP such as AP 274, AP 276, and AP 278 operating in different channels and typically different frequency bands (e.g., 2.4 GHZ, 5 GHZ, and 6 GHZ). AP 274, AP 276, and AP 278 may be the same as or similar to any one of the APs described above. Non-AP MLD 272 may include STA 280, STA 282, and STA 284, which may be the same as or similar to any of the STAs as described herein.

AP 274 may communicate with STA 280 via link 286. AP 276 may communicate with STA 282 via link 288. AP 278 may communicate with STA 284 via link 290. AP MLD 270 is shown in FIG. 2B to have access to a distribution system (DS) such as DS 292, which is a system used to interconnect a set of BSSs to create an extended service set (ESS).

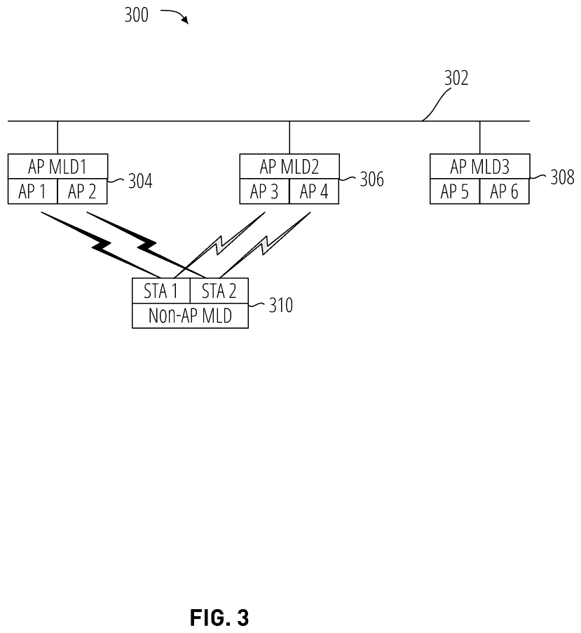

It should be understood that although the example shows three logical entities within the AP MLD and the three logical entities within the Non-AP MLD, this is merely for illustration purposes and that other numbers of logical entities within each of the AP MLD and Non-AP MLD may be envisioned. The example Wi-Fi systems and MLO described above with reference to FIGS. 1 and 2A-B provide examples of simplified and example systems of the present disclosure. Additional details of the present disclosure are provided in relation to FIGS. 3, 4, and 5.

FIG. 3 illustrates an example of a seamless mobility domain according to some aspect of the present disclosure.

FIG. 3 illustrates an example architecture of a Seamless Mobility Domain (SMD) shown as SMD 300 that includes a DS 302 (may be the same as DS 292) that is a logically connected entity that includes AP MLD1 304, AP MLD2 306, and AP MLD3 308, all of which can form an ESS (e.g., all AP MLDs which are part of a campus ESS network). SMD 300 also shows a Non-AP MLD 310 that may be connected to AP MLDI 304.

AP MLDI 304 may include one or more APs such as API and AP2. API and AP2 may be different physical APs (or AP interfaces) co-located in AP MLDI 304. Similarly, AP MLD2 306 may include one or more APs such as AP3 and AP4. AP3 and AP4 may be different physical APs (or AP interfaces) co-located in AP MLD2 306. Similarly, AP MLD3 308 may include one or more APs such as AP5 and AP6. AP5 and AP6 may be different physical APs (or AP interfaces) co-located in AP MLD3 308. The number of AP MLDs and/or the number of respective APs of each AP MLD is not limited to the example numbers shown in FIG. 2B and may include more or less.

In one example, AP MLD1 304, AP MLD2 306, and AP MLD3 308 may be located in different geographical locations (e.g., in different nearby locations in a building, different rooms of the same building, different floors of the same building, different buildings of the same campus or area, etc.). This may be referred to as non-co-located AP MLDs.

Non-AP MLD 310 may be any known or to be developed device capable of establishing one or more wireless communication links with one or more of AP MLD1 304, AP MLD2 306, and/or AP MLD3 308. As a non-limiting example, Non-AP MLD 310 may be a mobile device having two wireless interfaces, each of which may correspond to one of STA 1 or STA 2. In one example, each one of STA 1 and STA 2 may operate on a different link (e.g., 5 GHz for STA 1 and 6 GHz for STA 2). The number of Non-AP MLDs and/or STAs associated with each is not limited to that shown in FIG. 3 and may be more or less.

As shown in FIG. 3, Non-AP MLD 310 is associated with SMD 300, with multiple links setup with the AP MLD1 304 (for example, 2.4 GHz link with the API for STA 1 and 5 GHz link with the AP2 for the STA 2). For one of the links (for example, 2.4 GHZ), Non-AP MLD 310 may detect a weak RSSI. As a result, Non-AP MLD 310 determines a specific roaming target AP3 of AP MLD2 306 for that link to switch to. Similarly, the same process may be performed for the other link (for example, the 5 GHZ) to switch to a link with AP4 on AP MLD2 205.

In order to support seamless link level roaming for an ESS/NID/MDM/SMD (e.g., for MBBR), by way of an example, seamless link level roaming may be initiated by the current AP MLD (e.g., AP MLDI 304). Alternatively, seamless link level roaming may be based upon a request received from the Non-AP MLD (e.g., Non-AP MLD 310). Current AP MLD (may also be referred to as the source ap MLD) may send a frame, for example, a BSS Transition Management Request frame or any other known or to be developed management frame, to indicate to the Non-AP MLD one or more of: a) one or more ‘delete link’ operations for link(s) of the current AP MLD (in the old MLD's link ID space); and/or b) one or more ‘add link’ operations for link(s) of a new Target AP MLD such as the AP MLD2 306 (in the new MLD's link ID space), wherein the current AP MLD may indicate ‘add link’ operations for multiple candidate Target AP MLDs.

As described herein, the link space can be defined and identified corresponding to each AP MLD by the respective AP MLD MAC Address field included in the Reconfiguration ML clement. Accordingly, the frame, such as the BSS Transition Management Request frame, may include multiple Reconfiguration Multi-Link elements. Each Reconfiguration Multi-Link clement of the multiple Reconfiguration Multi-Link elements corresponds with each AP MLD for which either a link add, or a link delete operation is indicated in the frame. Further, as described herein, the link add operation may be indicated for multiple roaming candidate Target AP MLDs within the Link Reconfiguration Notify frame. In the Reconfiguration Multi-Link element, the MLD MAC Address may be set to the MLD MAC Address of the AP MLD for which the link add or the link delete operation is indicated.

Support for seamless/smooth roaming capability is a consideration for Wi-Fi 8 to improve Wi-Fi roaming quality. To support smooth roaming/mobility in network (e.g., a geographically dispersed network such as on a campus wide Wi-Fi network), clients can create association with the campus-network/ESS instead of with an individual AP MLD. The ESS might be represented by a mobility domain or, in the case that the network is a global network, then there can be multiple “sub-mobility domains” within a mobility domain, each of which can map to a single campus.

A client such as the Non-AP MLD 310 currently creates its association with the ESS network such as SMD 300, instead of associating with a single AP MLD (e.g., AP MLDI 304, AP MLD2 306, and/or AP MLD3 308) within the ESS. Such an architecture will enable a client to roam seamlessly between AP MLDs without requiring (re) association and reestablishment of contexts with each new AP MLD, since the client associates with the SMD covering all the AP MLDs of the ESS. Such an architecture can significantly reduce roaming time to realize seamless roaming. Signaling procedures to enable such seamless roaming are described in the present disclosure.

In Wi-Fi 7/802.11be, a Non-AP MLD associates with an AP MLD according to known or to be developed procedures. In Wi-Fi 8, a Non-AP MLD associates with an SMD (e.g., SMD 300) or SMD MLD (or NID or MDM) that cover multiple APs/AP MLDs of an ESS. In a Distributed MLO architecture for seamless roaming, multiple AP MLDs that are part of an SMD/SMD MLD would have a common Upper Upper MAC (U-UMAC) that provides a single MAC SAP to the DS covering the multiple APs/AP MLDs of the SMD/SMD MLD. In such a Distributed MLO architecture, a Non-AP MLD can have link setup with one or more AP MLDs within an SMD/SMD MLD.

For both cases (Wi-Fi 7 and Wi-Fi 8), the present disclosure introduces a mechanism to enable switch link operation to switch a current link to a new link (either within an AP MLD or across two AP MLDs) atomically. An atomic switch link operation may be defined as one where the entire operation either succeeds fully or is not executed (e.g., a delete link operation and an add link operation succeed together or else none would be carried out). This ensures that the Non-AP MLD would not end up in a situation where its current link got deleted, but the new link did not get added to its ML setup (e.g. because the AP or the associated link is already too crowded and a new STA can't be accepted on that link). This will be described in more detail below.

The 802.11be amendment defines the Link Reconfiguration Request/Response frames for add link and delete link operations. Using this, as described herein, a switch link operation can be achieved by including both delete link and add link within the same request frame.

In currently implemented/adopted procedures, the existing AP always accepts the delete link operation, not knowing the intent of the Non-AP MLD (e.g., to add a new link). The present disclosure proposes enhancements that address these deficiencies. More specifically, the proposed enhancements to the 802.11be Link Reconfiguration Request/Response signaling include providing support for an atomic switch link operation in the protocol within an AP MLD and across multiple AP MLDs (for roaming scenario).

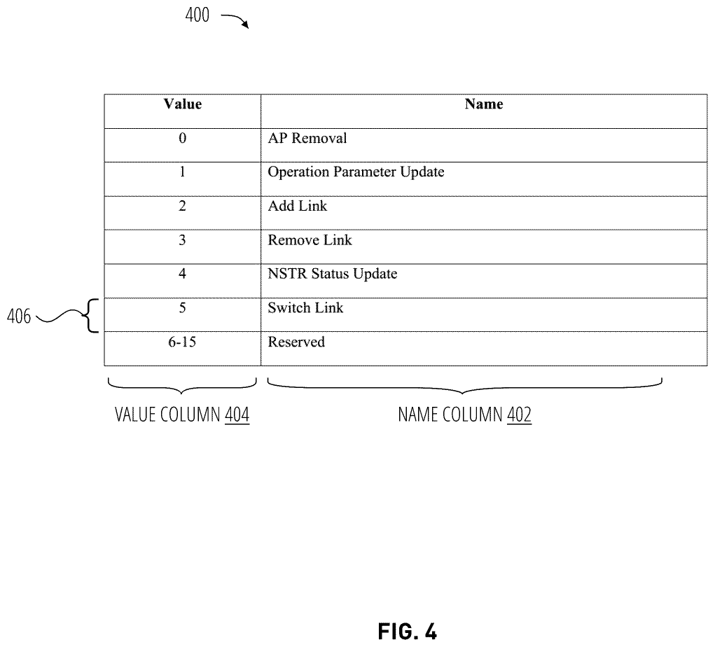

FIG. 4 illustrates an example encoding of a link reconfiguration element of a management frame to trigger a switch link operation according to some aspects of the present disclosure.

In one example embodiment, a management frame can be a Link Reconfiguration Request frame that has a Reconfiguration Multi-Link (ML) element both of which are defined in 802.11be standards. However, the present disclosure is not limited thereto and any other existing and/or newly defined management frame and/or elements thereof may be used instead.

In one example, a switch link operation type may be added to a Reconfiguration Operation Type subfield of the Reconfiguration ML element. Table 400 shows an example encoding of the Reconfiguration Operation Type subfield. As shown, Table 400 includes a name column 402 and a value column 404. Various functions may be defined in the name column 402 (e.g., AP Removal, Operation Parameter Update, Add Link, Delete Link, Non-Simultaneous Transmit and Receive (NSTR) Status Update, etc.), which each having a corresponding numeral value reserved and indicated in the value column 404.

According to some aspects of the present disclosure, a new switch link function 406 may be encoded in table 400 of the subfield with a corresponding numerical value (e.g., 5 or any other unused and reserved numerical value (e.g., 6-15).

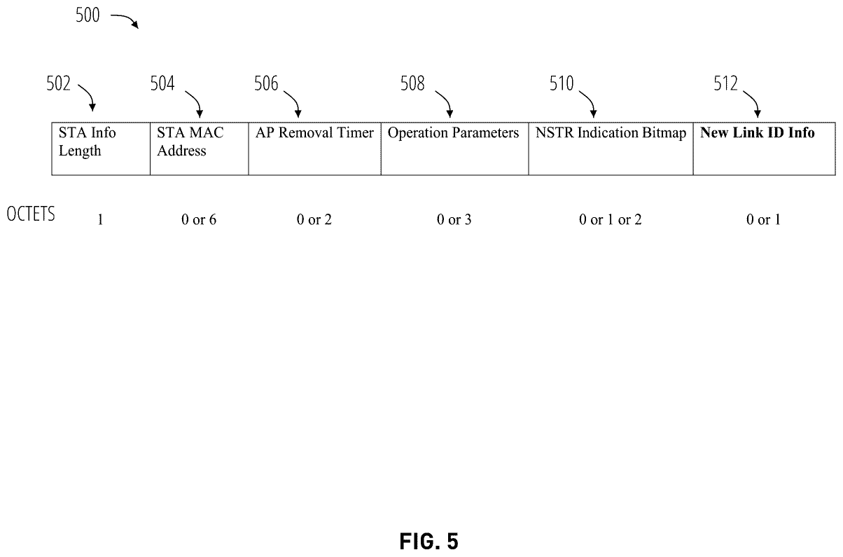

FIG. 5 illustrates an example of a Reconfiguration ML element modified to include switch link operation information according to some aspects of the present disclosure. Element 500 is an example format of the STA Information field of a Reconfiguration ML element that includes STA Info Length 502, STA MAC address 504, AP Removal Timer 506, Operation Parameters 508, NSTR Indication Bitmap 510, as defined in the standards, each having their respective number of octets as shown in FIG. 5.

According to one aspect of the present disclosure, the element 500 may be modified to also include a new field that may be referred to as New Link Identifier Info (New Link ID Info 512). New Link ID Info 512 may include information identifying the new link for a Non-AP MLD (e.g., Non-AP MLD 310) to switch to.

In one example, the Reconfiguration ML element may include a separate STA Profile subelement for each STA associated with a Non-AP MLD (e.g., STA 1 and STA 2 of Non-AP MLD 310). This may be referred to as a per-STA Profile subelement. In this example, each STA profile subelement includes a Reconfiguration Operation Type subfield with the switch link operation encoded as shown in FIG. 4 and a corresponding Reconfiguration ML element with the corresponding New Link ID Info as shown in FIG. 5.

In one example, in a per-STA Profile subelement, the following fields may be set. The Link ID is set to the link identifier of the current link that the Non-AP MLD is requesting to switch to a new link (e.g., current 2.4 GHz link that STA 1 of Non-AP MLD 310 is communicating on with AP 1 of AP MLDI 304).

Furthermore, New Link ID Info 512 in the STA Info field of element 500 is set to indicate the link identifier of the new link to be switched to (e.g., new 2.4 GHz link that STA 1 of Non-AP MLD 310 is going to switch to communicate with AP 3 of AP MLD2 306).

Furthermore, the Complete Profile subfield is set to 1 to include the STA Profile field. The STA Profile field includes the complete profile for the new link to be switched to, which is identified by New Link ID Info 512 for each STA.

In some example embodiments, the new link to be switched to may be recommended to Non-AP MLD 310 by AP MLDI 304 that Non-AP MLD 310 is currently connected to. For instance, the switch link operation can also be used in the Link Reconfiguration Notify frame by the AP MLD1 304 to recommend that the Non-AP MLD 310 switches one of its current links (e.g., the link for STA 1 and/or the link for STA 2) to a new link, as indicated in the Per-STA Profile subelement in the Link Reconfiguration Notify frame. In one example, the new link may be a new link associated with the current AP MLD1 304 (e.g., 5 GHz link instead of the 2.4 GHZ link) or a new link associated with a different AP MLD such as the AP MLD2 306 in the same SMD (e.g., SMD 300).

To support atomic switch link operation across multiple AP MLDs within an SMD/SMD MLD/MDM, the following steps may be taken.

The Non-AP MLD (e.g., the Non-AP MLD 310) includes a Reconfiguration ML element with the Reconfiguration Operation Type set to, for example, 5 (switch link) in the Link Reconfiguration Request frame, as described above with reference to FIG. 4. Additionally, New Link ID Info 512 may be extended to also include the AP MLD MAC Address of the new AP MLD (e.g., AP MLD2 306) with which the new link needs to be setup, to provide the context for the link ID space for the new link (e.g., a 5 GHz link with STA 4 of AP MLD2 306). The STA Profile field may include the complete profile for the new link scoped based on the AP MLD MAC Address of the new AP MLD (e.g., in the included Basic ML element).

Furthermore, Non-AP MLD 310 may send the Link Reconfiguration Request frame to its current AP MLD (e.g., AP MLD1 304), with which the Non-AP MLD 310 has the current link and is requesting to be switched to another link (e.g., a new link with AP MLD2 306).

Then, current AP MLD performs an AP-to-AP exchange for switch link with the new AP MLD (e.g., the AP MLD2 306), where the current AP MLD requests the new AP MLD to add the new link for the Non-AP MLD 310. This AP-to-AP add link can be achieved using the Link Reconfiguration Request/Response frames indicating an ‘add link’ operation. However, the present disclosure is not limited thereto, and other known or to be development management frames may be used instead.

In response, if new AP MLD2 306 accepts the add link request, the new AP MLD2 306 responds with a success message to the current AP MLDI 304 and returns an Association Identifier (AID) for the Non-AP MLD 310, defined within the space of the new AP MLD2 306. In response, the current AP MLD1 304, after receiving a success for the add link operation from the new AP MLD2 306, will send a Link Reconfiguration Response back to the Non-AP MLD 310, indicating success for switch link operation, and provides the AID assignment from the new AP MLD2 306 (scoped within the new AP MLD AID space, per AP MLD MAC address of the new AP MLD2 306).

However, if current AP MLD1 304 receives a failure for the add link operation from new AP MLD2 306, he current AP MLD1 304 does not delete the current link for the Non-AP MLD 310 which was identified for the switch link (to switch from). Subsequently, current AP MLD1 304 may send a failure response to Non-AP MLD 310 indicating a failure for the switch link operation.

In another example, a separate element can be included in the Link Reconfiguration Request frame to indicate ‘switch link’ operation across two new AP MLDs (e.g., AP MLD2 306 and AP MLD3 308). In this example, two separate Reconfiguration ML element is included, one for each of the new AP MLDs, indicating ‘delete link’ for a current link with the AP MLD1 304 and ‘add ink’ for a respective one of the new AP MLDs. Additionally, a new Reason Code (e.g. PERFORM_SWITCH_LINK) can be included in the Link Reconfiguration Request frame to signal that Non-AP MLD 310 is requesting a switch link operation (e.g., in an atomic manner).

In another example, the Non-AP MLD 310 can trigger an atomic switch link operation across multiple of its links across two AP MLDs, using the same mechanism as described above, and indicate a pair of links for each switch link operation. In this example, current AP MLD1 304 will only complete the entire switch link operation if the switch link for all the indicated links can be completed successfully.

In another example, Non-AP MLD 310 sends the Link Reconfiguration Request frame to the new AP MLD (e.g., AP MLD2 306) instead of current AP MLD (e.g., AP MLDI 304), with which by virtue of being part of SMD 300 as current AP MLD, can initiate the switch link operation with current AP-MLD.

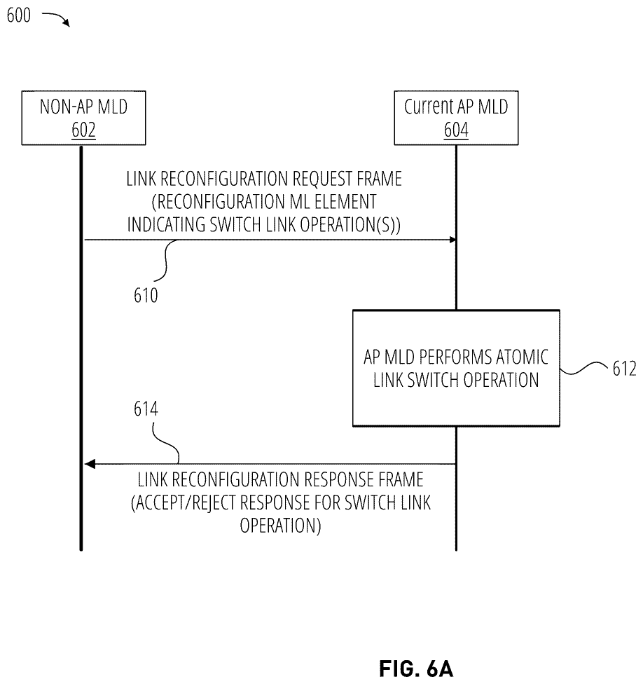

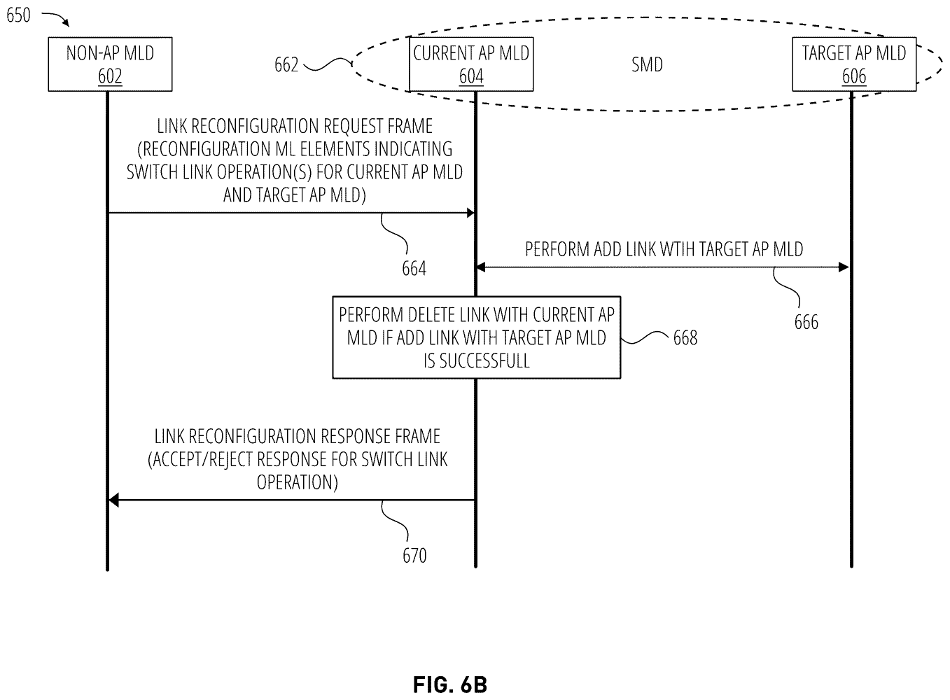

FIG. 6A illustrates an example of a signaling exchange between a Non-AP MLD and a current AP MLD for performing switch link operation according to some aspects of the present disclosure.

Example signaling exchange 600 may take place between Non-AP MLD 602 and Current AP MLD 604 (which may also be referred to as serving AP MLD). Non-AP MLD 602 may be the same as Non-AP MLD 310 of FIG. 3 and/or Non-AP MLD 272 of FIG. 2B. Current AP MLD 604 may be the same as AP MLD1 304 of FIG. 3 and/or AP MLD 270 of FIG. 2B.

Signaling exchange 610 may involve Non-AP MLD 602 sending a signaling frame (e.g., Link Reconfiguration Request Frame) to Current AP MLD 604. As described above with reference to FIGS. 4 and 5, an element in the signaling frame (e.g., Reconfiguration ML element in the Link Reconfiguration Request frame) may be modified to indicate a switch link operation(s).

Upon receiving the signaling frame, Current AP MLD 604 may perform process 612, which is an atomic link switch operation. In one example, the switch link operation indicated in the signaling frame sent by Non-AP MLD 602 may include a request to delete a current communication link between Non-AP MLD 602 and Current AP MLD 604 (e.g., a 2.4 GHz link between STA 1 of Non-AP MLD 310 and API of AP MLD1 304) and add a new communication link between Non-AP MLD 602 and Current AP MLD 604 (e.g., a 5 GHz link between STA 1 of Non-AP MLD 310 and AP2 of AP MLDI 304). As noted above, the newly requested communication link may be with an AP of another AP MLD such as AP MLD2 306.

As will be described below, a switch link operation may be requested (triggered) based on any one or more factors including, but not limited to, a recommended link switch by Current AP MLD 604 (e.g., based on current load of each AP MLD in a given ESS, etc.) or may be triggered by one or more conditions observed by Non-AP MLD 602 (e.g., RSSI on current links between Non-AP MLD 602 and Current AP MLD 604, data throughput, etc.).

As described above, an atomic switch is defined as one where Current AP MLD 604 successfully completes both the process of deleting the current communication link and adding the new communication link. If either one fails, the switch link operation fails.

The process of adding a link and/or deleting a link may be performed according to any known or to be developed protocol and mechanism, such as those defined (or to be defined) in the standards of 802.11bc.

Depending on the result of the atomic switch link operation at process 612, Current AP MLD 604 sends a response frame at signaling exchange 614 back to Non-AP MLD 602. The response frame may include a success (accept) or failure (reject) response indicating whether the switch link operation was successfully completed (atomically) or failed.

FIG. 6B illustrates an example of a signaling exchange between a Non-AP MLD and a current AP MLD for performing switch link operation across multiple AP MLDs according to some aspects of the present disclosure.

Example signaling exchange 650 may take place between Non-AP MLD 602, Current AP MLD 604 (which may also be referred to as serving AP MLD), and Target AP MLD 606 (which may be referred to as new AP MLD). In one example, Non-AP MLD 602 may be the same as Non-AP MLD 310 of FIG. 3 and/or Non-AP MLD 272 of FIG. 2B. Current AP MLD 604 may be the same as AP MLD1 304 of FIG. 3 and/or AP MLD 270 of FIG. 2B. Target AP MLD 606 may be the same as AP MLD2 306 and/or AP MLD3 308 of FIG. 3. In one example, Current AP MLD 604 and Target AP MLD 606 may be part of the same SMD 662, which may be the same as SMD 300 of FIG. 3.

Signaling exchange 664 may involve Non-AP MLD 602 sending a signaling frame (e.g., Link Reconfiguration Request Frame) to Current AP MLD 604. As described above with reference to FIGS. 4 and 5, an element in the signaling frame (e.g., Reconfiguration ML element in the Link Reconfiguration Request frame) may be modified to indicate a switch link operation(s) for Current AP MLD 604 and Target AP MLD 606.

The switch link operation indicated in the signaling frame sent by Non-AP MLD 602 may include a request to delete a current communication link between Non-AP MLD 602 and Current AP MLD 604 (e.g., a 2.4 GHz link between STA 1 of Non-AP MLD 310 and API of AP MLD1 304) and add a new communication link between Non-AP MLD 602 and Target AP MLD 606 (e.g., a 5 GHz link between STA 1 of Non-AP MLD 310 and AP3 of AP MLD2 306).

Next, signaling exchange 666 may take place between Current AP MLD 604 and Target AP MLD 606, where Current AP MLD 604 may perform a process to add the new communication link with Target AP MLD 606 per the switch link operation.

If adding the new link with Target AP MLD 606 is successful, Current AP MLD 604 may then complete the process 668 that includes deleting the current communication link between Non-AP MLD 602 and Current AP MLD 604.

As noted above, a switch link operation may be requested (triggered) based on any one or more factors including, but not limited to, a recommended link switch by Current AP MLD 604 (e.g., based on current load of each AP MLD in a given ESS, etc.) or may be triggered by one or more conditions observed by Non-AP MLD 602 (e.g., RSSI on current links between Non-AP MLD 602 and Current AP MLD 604, data throughput, etc.).

In the context of implementing a switch link operation across multiple AP MLDs, an atomic switch is defined as one where Current AP MLD 604 successfully completes both the process of adding the new communication link between Non-AP MLD 602 and Target AP MLD 606 and deleting the current communication link between Non-AP MLD 602 and Current AP MLD 604. If either one fails, the switch link operation fails.

The process of adding a link and/or deleting a link may be performed according to any known or to be developed protocol and mechanism, such as those defined (or to be defined) in the standards of 802.11bc.

Depending on the result of the atomic switch link operation via signaling exchange 666 and process 668, Current AP MLD 604 sends a response frame at signaling exchange 670 back to Non-AP MLD 602. The response frame may include a success (accept) or failure (reject) response indicating whether the switch link operation was successfully completed (atomically) or failed.

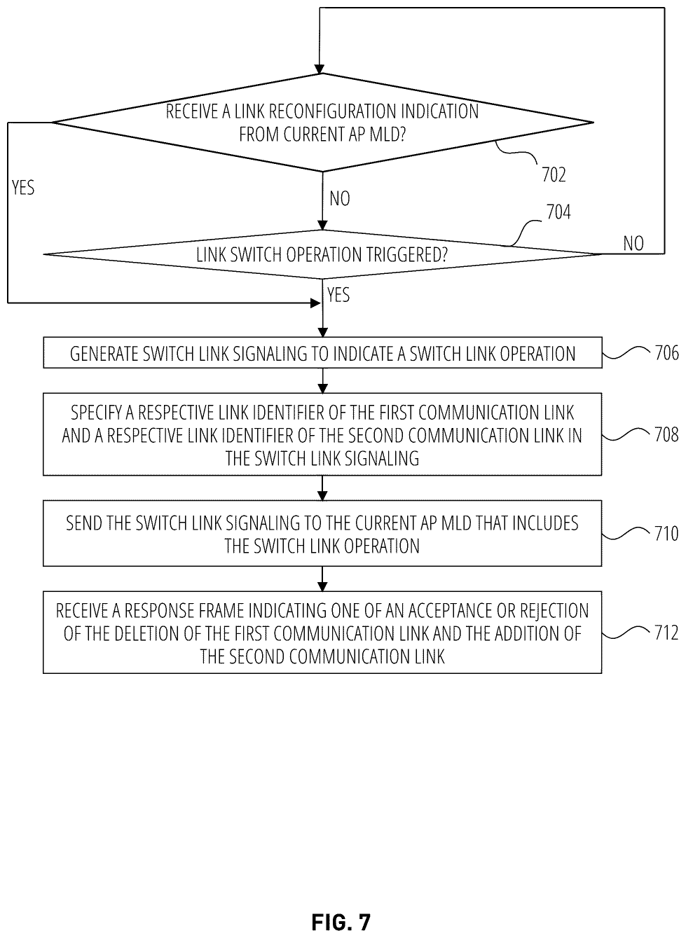

FIG. 7 illustrates an example of a switch link operation process according to some aspects of the present disclosure. As a non-limiting example and for purposes of a simplified description, references will be made to various components of SMD 300 of FIG. 3 as well as FIGS. 4-6A-B in describing steps of FIG. 7. Furthermore, steps of FIG. 7 will be described from the perspective of Non-AP MLD 310. It should be understood that Non-AP MLD 310 may have one or more memories having computer-readable instructions stored therein and one or more processors configured to execute the computer-readable instructions to implement steps of FIG. 7 as described above.

At step 702, Non-AP MLD 310 may determine whether a link reconfiguration indication is received from a current AP MLD to which Non-AP MLD 310 is connected (e.g., AP MLDI 304). As noted above, this process may include receiving a link reconfiguration notification frame from the current AP MLD. The link reconfiguration notification frame may include the switch link operation, based on which the switch link operation may be generated at step 706. The link reconfiguration indication may be sent by current AP MLD for any number of reasons (e.g., based on current load of each AP MLD in a given ESS, etc.).

If at step 702, Non-AP MLD 310 determines that such link reconfiguration indication is received from current AP MLD, then the process proceeds to step 706, which will be described below. However, if Non-AP MLD 310 determines that no such link reconfiguration indication is received, then at step 704, Non-AP MLD 310 may determine if a switch link operation is triggered. As described above, a number of parameters (detected by Non-AP MLD 310) may trigger a switch link operation to be initiated including, but not limited to, RSSI on current links between Non-AP MLD 602 and Current AP MLD 604, data throughput, etc.

If at step 704, Non-AP MLD 310 determines that a switch link operation is not triggered, the process reverts back to step 702 and step 702 and/or step 704 are repeated until a switch link operation is triggered. In one example, step 702 and step 704 may be performed periodically or continuously.

However, if at step 704, Non-AP MLD 310 determines that the switch link operation is triggered, then the process proceeds to step 706.

At step 706, Non-AP MLD 310 may generate a switch link signaling to indicate a switch link operation to trigger a deletion of a first communication link between the Non-AP MLD and a current AP MLD and addition of a second communication link. As described above with reference to FIG. 4, the switch link operation can utilize any known or to be developed control management signaling and frame that can be used to signal link reconfiguration procedures between AP MLD(s) and Non-AP MLDs (e.g., any known or to be developed 802.11be frame and signaling). A non-limiting example of such signaling is a reconfiguration multi-link element that may be sent from Non-AP MLD 310 to current AP MLD in a Link Reconfiguration Request frame. In one example, the switch link signaling includes a reconfiguration multi-link element, and generating the switch link signaling includes adding the switch link operation in a reconfiguration operation type subfield of the reconfiguration multi-link element, as described above with reference to FIG. 4 (e.g., including a numeric value of ‘5’ to indicate the switch link operation).

In one example, the switch link signaling can include a reason field specifying the reason for the switch link operation (e.g., overloading of current AP MLD, data throughput that is less than a threshold, QoS violation, suboptimal performance based on Service Level Agreement (SLA), etc.).

Thereafter, at step 708, Non-AP MLD 310 may further specify, in the switch link signaling, a link identifier of a current communication link (first communication link) that is currently used by a STA of Non-AP MLD 310 (e.g., STA 1) to communicate with Current AP MLD (e.g., a current 2.4 GHz link between STA 1 of Non-AP MLD 310 and AP 1 of AP MLDI 304). Non-AP MLD 310 may further include an identifier of a new communication link (second communication link) that one or more STAs of Non-AP MLD 310 would switch to from the current communication link (e.g., a 5 GHz link between Non-AP MLD 310 and AP 2 of AP MLDI 304, a new link with AP 3 of AP MLD2 306, etc.). Accordingly, the first and the second communication links may be associated with the current AP MLD.

Alternatively, the first and the second communication links may be associated with different AP MLDs (e.g., AP MLD1 304 and AP MLD2 306, which may not be physically co-located). In one example, the current AP MLD and the target AP MLD are part of a seamless mobility domain (e.g., SMD 300). In this instance, a seamless mobility domain identifier that identifies the seamless mobility domain to which the current AP MLD and target AP MLD belong, may be included in the switch link signaling.

In one example, when the first communication link and the second communication link are associated with different AP MLDs, respective link identifier of the second communication link includes a respective MAC address of the target AP MLD with which the second communication link associated. In another example, the respective link identifier of the second communication link may include an STA address of affiliated AP of the target AP MLD.

The process of current link identifier and new link identifier inclusion may be performed as described above with reference to FIG. 5.

For instance, Non-AP MLD 310 can include a per-STA profile subelement in the reconfiguration multi-link clement, and the switch link operation is set in the per-STA profile subelement of at least one STA (e.g., STA 1) associated with Non-AP MLD 310. The reconfiguration multi-link element includes a respective complete profile subfield for each STA associated with the Non-AP MLD 310. In one example, when the respective complete profile subfield is set to 1, a respective STA profile field includes a complete profile of the second communication link including the New Link ID Info as described with reference to FIG. 5.

At step 710, Non-AP MLD 310 may send the switch link signaling to the current AP MLD that includes the switch link operation, the respective link identifier of the first communication link, and the respective link identifier of the second communication link. As described above, in one example, instead of sending the signaling element to the Current AP MLD to which Non-AP MLD 310 is connected (e.g., AP MLD1 304), Non-AP MLD 310 may send the signaling element to a target AP MLD (e.g., AP MLD2 306 and/or AP MLD3 308, which are in the same SMD such as SMD 300 with current AP MLDI 304).

In one example embodiment, sending the switch link signaling includes sending a link reconfiguration request frame that includes the reconfiguration multi-link clement with the reconfiguration operation type subfield specified as described above.

In another example, when the current AP MLD and the target AP MLD are not physically co-located (e.g., when the first communication link and the second communication link are associated with different AP MLDs), the switch link signaling may include a first reconfiguration multi-link element indicating a delete link operation for the first communication link and a second reconfiguration multi-link clement indicating add link operation for the second communication link, and another indication to trigger the switch link operation. In this instance, sending the switch link signaling includes sending a link reconfiguration request frame that includes the first reconfiguration multi-link element and the second reconfiguration multi-link element.

After sending the signaling element, in one example embodiment, current AP MLD that receives the signaling element may perform an atomic switch link operation as described above with reference to FIG. 6A. In another example embodiment, current AP MLD may perform an atomic switch link operation with a target AP MLD when the second communication link to be added is at a different AP MLD than the current AP MLD. This process may be performed as described above with reference to FIG. 6B and involves an AP-to-AP exchange.

Such AP-to-AP exchange may include an acceptance of the addition of the second communication link by the Target AP MLD or a rejection of the addition of the second communication link by the Target AP MLD. Upon acceptance, target AP MLD may delete the first communication link with the current AP MLD and send an Association Identifier (AID) associated with the Target AP MLD, to the Current AP MLD and then the current AP MLD sends the AID to the Non-AP MLD in the response frame.

However, if target AP MLD rejects the addition, target AP MLD notifies the current AP MLD of the rejection and thus current AP MLD does not delete the first communication link. Thereafter, current AP MLD notifies Non-AP MLD 310 that the atomic switch operation has failed.

At step 712, Non-AP MLD 310 may receive a response frame indicating one of an acceptance (completion) or rejection of the deletion of the first communication link and the addition of the second communication link.

In another example, acceptance of rejection of an AP-to-AP exchange and hence completion of the switch link operation may be communicated back to Non-AP MLD 310 by the target AP MLD instead of current AP MLD.

The process of FIG. 7 is described in the context of addition of a single new link and deletion of a single current link. However, the present disclosure is not limited thereto. For example, Non-AP MLD 310 may perform a switch link operation for two or more of its current links (a plurality of first communication links). In such example, the process of FIG. 7 may be performed for each of the current links of Non-AP MLD 310.

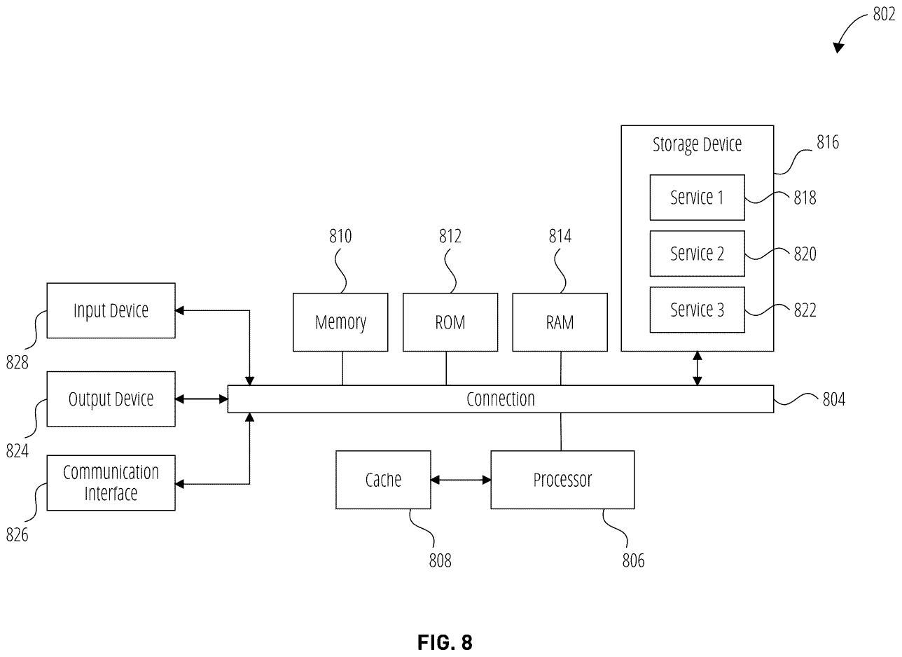

FIG. 8 shows an example of computing system according to some aspects of the present disclosure. Computing system 802 can be for example any computing device making up any of the devices described above with reference to FIGS. 1-7 (e.g., Non-AP MLD 310, AP MLD1 304, AP MLD2 306, AP MLD3 308, etc.). Components of computing system 802 system are in communication with each other using connection 804. Connection 804 can be a physical connection via a bus, or a direct connection into processor 806, such as in a chipset architecture. Connection 804 can also be a virtual connection, networked connection, or logical connection.

In some embodiments, computing system 802 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 802 includes at least one processing unit (CPU) or processors 806 and connection 804 that couples various system components including system memory 810, a read-only memory (ROM) such as ROM 812, and a random-access memory (RAM) such as RAM 814 to processor 806. Computing system 802 can include a cache 808 of high-speed memory connected directly with, in close proximity to, or integrated as part of processor 806.

Processor 806 can include any general-purpose processor and a hardware service or software service, such as services 818, 820, and 822 stored in storage device 816, configured to control processor 806 as well as a special-purpose processor where software instructions are incorporated into the actual processor design. Processor 806 may essentially be a completely self-contained computing system, containing multiple cores or processors, a bus, memory controller, cache, etc. A multi-core processor may be symmetric or asymmetric.

To enable user interaction, computing system 802 includes an input device 828, which can represent any number of input mechanisms, such as a microphone for speech, a touch-sensitive screen for gesture or graphical input, keyboard, mouse, motion input, speech, etc. Computing system 802 can also include output device 824, which can be one or more of a number of output mechanisms known to those of skill in the art. In some instances, multimodal systems can enable a user to provide multiple types of input/output to communicate with computing system 802. Computing system 802 can include communication interface 826, which can generally govern and manage the user input and system output. There is no restriction on operating on any particular hardware arrangement, and therefore the basic features here may easily be substituted for improved hardware or firmware arrangements as they are developed.

Storage device 816 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 816 can include software services, servers, services, etc., that when the code that defines such software is executed by the processor 806, it causes the system to perform a function. In some embodiments, a hardware service that performs a particular function can include the software component stored in a computer-readable medium in connection with the necessary hardware components, such as processor 806, connection 804, output device 824, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method comprising:
generating, by a Non-Access Point Multi-link Device (Non-AP MLD), a switch link signaling to indicate a switch link operation to trigger a deletion of a first communication link between the Non-AP MLD and a current AP MLD and addition of a second communication link;
specifying, by the Non-AP MLD, a respective link identifier of the first communication link and a respective link identifier of the second communication link in the switch link signaling;
sending, by the Non-AP MLD, the switch link signaling to the current AP MLD that includes the switch link operation, the respective link identifier of the first communication link, and the respective link identifier of the second communication link; and
receiving, at the Non-AP MLD, a response frame indicating one of an acceptance or rejection of the deletion of the first communication link and the addition of the second communication link.

2. The method of claim 1, wherein the switch link signaling includes a reconfiguration multi-link element, and generating the switch link signaling includes adding the switch link operation in a reconfiguration operation type subfield of the reconfiguration multi-link element.

3. The method of claim 2, wherein sending the switch link signaling includes sending a link reconfiguration request frame that includes the reconfiguration multi-link element.

4. The method of claim 1, further comprising:
receiving a link reconfiguration notification frame from the current AP MLD, the link reconfiguration notification frame including the switch link operation, wherein the switch link signaling is generated based on the switch link operation received as part of the link reconfiguration notification frame.

5. The method of claim 1, wherein the first communication link and second communication link are associated with the current AP MLD.

6. The method of claim 1, wherein,
the second communication link is associated with a target AP MLD, and
the current AP MLD and the target AP MLD are not physically co-located.

7. The method of claim 6, wherein the current AP MLD and the target AP MLD are part of a seamless mobility domain, and wherein a seamless mobility domain identifier is included in the switch link signaling that identifies the seamless mobility domain to which the current AP MLD and target AP MLD belong.

8. The method of claim 6, wherein the respective link identifier of the second communication link includes a respective MAC address of the target AP MLD.

9. The method of claim 6, wherein upon receiving the switch link signaling, as part of a reconfiguration request frame, from the Non-AP MLD, the current AP MLD performs an AP-to-AP exchange with the target AP MLD to add the second communication link with the target AP MLD and delete the first communication link with the current AP MLD.

10. The method of claim 6, wherein,
the switch link signaling comprises a first reconfiguration multi-link element indicating delete link operation for the first communication link and a second reconfiguration multi-link element indicating add link operation for the second communication link, and another indication to trigger the switch link operation, and
sending the switch link signaling includes sending a link reconfiguration request frame that includes the first reconfiguration multi-link element and the second reconfiguration multi-link element.

11. A Non-Access Point Multi-Link Device (Non-AP MLD) comprising:
one or more memories having computer-readable instructions stored therein; and
one or more processors configured to execute the computer-readable instructions to:
generate a switch link signaling to indicate a switch link operation to trigger a deletion of a first communication link between the Non-AP MLD and a current AP MLD and addition of a second communication link;
specify a respective link identifier of the first communication link and a respective link identifier of the second communication link in the switch link signaling;
send the switch link signaling to the current AP MLD that includes the switch link operation, the respective link identifier of the first communication link, and the respective link identifier of the second communication link; and
receive a response frame indicating one of an acceptance or rejection of the deletion of the first communication link and the addition of the second communication link.

12. The Non-Access Point Multi-Link Device of claim 11, wherein the switch link signaling includes a reconfiguration multi-link element, and the one or more processors are configured to execute the computer-readable instructions to generate the switch link signaling by adding the switch link operation in a reconfiguration operation type subfield of the reconfiguration multi-link element.

13. The Non-Access Point Multi-Link Device of claim 12, wherein the one or more processors are configured to execute the computer-readable instructions to send the switch link signaling by sending a link reconfiguration request frame that includes the reconfiguration multi-link element.

14. The Non-Access Point Multi-Link Device of claim 11, wherein the one or more processors are configured to execute the computer-readable instructions to:
receive a link reconfiguration notification frame from the current AP MLD, the link reconfiguration notification frame including the switch link operation, wherein the switch link signaling is generated based on the switch link operation received as part of the link reconfiguration notification frame.

15. The Non-Access Point Multi-Link Device of claim 11, wherein the first communication link and second communication link are associated with the current AP MLD.

16. The Non-Access Point Multi-Link Device of claim 11, wherein,
the second communication link is associated with a target AP MLD, and
the current AP MLD and the target AP MLD are not physically co-located.

17. The Non-Access Point Multi-Link Device of claim 16, wherein the current AP MLD and the target AP MLD are part of a seamless mobility domain, and wherein the one or more processors are configured to execute the computer-readable instructions to include, in the switch link signaling, a seamless mobility domain identifier that identifies the seamless mobility domain to which the current AP MLD and target AP MLD belong.

18. The Non-Access Point Multi-Link Device of claim 16, wherein the respective link identifier of the second communication link includes a respective MAC address of the target AP MLD.

19. The Non-Access Point Multi-Link Device of claim 16, wherein upon receiving the switch link signaling, as part of a reconfiguration request frame, from the Non-AP MLD, the current AP MLD performs an AP-to-AP exchange with the target AP MLD to add the second communication link with the target AP MLD and delete the first communication link with the current AP MLD.

20. The Non-Access Point Multi-Link Device of claim 16, wherein,
the switch link signaling comprises a first reconfiguration multi-link element indicating delete link operation for the first communication link and a second reconfiguration multi-link element indicating add link operation for the second communication link, and another indication to trigger the switch link operation, and
sending the switch link signaling includes sending a link reconfiguration request frame that includes the first reconfiguration multi-link element and the second reconfiguration multi-link element.
